(19) United States
(12) Patent Application Publication
(10) Pub. No.: US 2025/0061102 A1
(43) Pub. Date: Feb. 20, 2025

(54) SYSTEMS AND METHODS FOR CARBON-RELATED DATA MANAGEMENT

(71) Applicant: BANK OF MONTREAL, Toronto (CA)

(72) Inventors: Brent Thumlert, Toronto (CA); Ryan Hilliker, Toronto (CA)

(21) Appl. No.: 18/807,761

(22) Filed: Aug. 16, 2024

Related U.S. Application Data
(60) Provisional application No. 63/533,336, filed on Aug. 17, 2023.

(51) Int. Cl. G06F 16/22; G06F 16/248; G06Q 30/018

(52) U.S. Cl. CPC G06F 16/2246; G06F 16/248; G06Q 30/018

(57) ABSTRACT

Disclosed herein are methods to create data objects for efficient database management. During a first electronic session, a device, using one or more processors, collects carbon-related data including attributes of protocols performed by an entity. This data is used to create an immutable data object organized according to a hierarchical tree structure, representing relationships between devices and locations involved in the protocols. The immutable data object is then stored as a record in a dynamic field of a relational database. In a subsequent electronic session, upon receiving a request related to the entity, the device queries this record. The query accesses the data via the hierarchical structure to retrieve protocol attributes. Finally, based on this retrieved data, the device generates one or more carbon credits.

### CROSS-REFERENCE TO RELATED APPLICATIONS

This application claims priority to U.S. Provisional Patent Application No. 63/533,336, filed Aug. 17, 2023, which is incorporated herein by reference in its entirety for all purposes.

### TECHNICAL FIELD

This application generally relates to methods and systems for more efficient data management and faster data queries.

### BACKGROUND

Due to the rising concerns over climate change driven by greenhouse gas emissions, certain caps on emissions for various industries and companies have been imposed. Within these limits, entities are assigned a specific number of carbon incentives, where each incentive corresponds to one ton of CO2 equivalent emissions. Carbon-related data is usually generated from diverse initiatives including renewable energy projects, afforestation, reforestation, energy efficiency measures, and the adoption of cleaner technologies. The generation process hinges on the meticulous measuring, monitoring, reporting, and verifying (MMRV) of related data. Technical hurdles predominantly arise in setting accurate baselines and establishing additionality. Baseline calculations, which predict the emission levels in the absence of the project, require sophisticated data analysis and forecasting.

Conventional methods and systems use conventional database management solutions/systems to store and analyze data related to carbon-related data. However, these methods and systems have faced significant technical challenges. In one example, these calculations are prone to significant errors and uncertainties due to their complexity and the variability of factors involved. Furthermore, demonstrating additionality is essential to ensuring that incentives are only allocated for genuine emission reductions that surpass standard operational levels. This requires thorough documentation and evaluations by internal and/or third-party auditors.

Another technical shortcoming relates to a prevalent issue of data organization, querying, and retrieval. Collected data associated with carbon typically belong to a diverse range of data types. For instance, the data often consists of an unwieldy amalgamation of files, photographs, and spreadsheets. Conventional data management systems face significant technical challenges in managing carbon-related data, primarily due to the diverse and complex nature of the data involved. Conventional data management systems often rely on disparate data storage methods, such as spreadsheets and local databases, which can lead to inconsistencies, data loss, and difficulties in data retrieval and validation. These systems are not designed to handle the high volume and variability of data required for accurate MMRV processes, nor are they equipped to seamlessly integrate data from various sources. Furthermore, the lack of standardized data formats and protocols complicates the aggregation and comparison of data across different projects and jurisdictions. This disjointed and inefficient approach not only hampers the ability to track and verify emission reductions effectively but also increases the risk of errors and fraud, ultimately undermining the credibility and effectiveness of carbon-related data programs.

### SUMMARY

For the aforementioned reasons, there is a need for a computer-implemented system and method that enables record keeping of complex relations that is easily verifiable and presentable to an auditor with built-in safety measures that guarantee accurate generation of carbon-related incentives. With auditing practices increasingly focusing on the reliability and security of data capture systems rather than the individual claims and evidence, there is an urgent technical need for a centralized, computer-implemented solution. Such a system would streamline access to carbon-related data, enhancing both organization and reliability, thereby addressing the critical technical challenges in the carbon-related data generation process.

Conventional data management solutions struggle to efficiently query data associated with carbon projects due to their inherently siloed and unstructured data storage practices. These traditional systems lack the necessary scalability and flexibility to handle the diverse, complex datasets typical of carbon projects, such as emission levels, project metrics, and verification reports. This complexity is compounded by varying data formats and standards, which impede efficient data integration and retrieval. Without advanced querying capabilities and uniform data structuring, stakeholders face significant delays and challenges in accessing critical information, analyzing trends, and making data-driven decisions. These inefficiencies not only slow down project monitoring and reporting processes but also hinder real-time data access, essential for responsive and adaptive management of carbon reduction initiatives.

Embodiments disclosed herein address the above challenges and other additional challenges by providing a system that records immutable data associated with carbon-related data generation and provides access to the data via an exportable data objects, which may result in a semi-automated (e.g., automated) process for managing, creating, and verifying carbon-related data, reduction of time resources, more reliable data, and increased efficiency, among other advantages. For instance, an analytic server may collect data corresponding to a carbon-related data generation project. The analytic server may generate a dynamic data object for the project that includes the data organized according to a hierarchical structure. The analytic server may store the dynamic data object as a data record within a dynamic field of a database and generate carbon-related data based on the dynamic data object. Furthermore, the analytic server may generate an exportable data object of the data record according to one or more preferences of a type of audit procedure.

The analytic server may collect the data from field operators via a form on a mobile application or from third party service providers through one or more scrubbing techniques. The analytic server may process the data using one or more hashing techniques and compare the data against prior data records stored in the database to determine whether the data is a duplicate of prior data. The analytic server may classify the data and generate the dynamic data object to be stored as the data record within the dynamic field based on a hierarchical structure. Furthermore, the analytic server may determine the type of audit procedure and modify one or more configurations of the hierarchical structure to generate the exportable data object according to the one or more preferences of the type of audit procedure, allowing the audit procedure to verify the amount of carbon-related data generated.

Using the methods and systems discussed herein provide significant technical advantages over conventional data management solutions for handling carbon-related data. By introducing a robust, scalable approach to recording and accessing immutable data associated with carbon-related generation, the system ensures the integrity and verifiability of carbo-related data, which is pivotal for maintaining credibility in financial and environmental contexts. The methods and systems discussed herein allow for storing data in an immutable format, meaning once information is entered, it cannot be altered, thus providing a traceable and tamper-proof record. This is crucial for preserving the data's reliability.

The methods and systems discussed herein provide for storing data in a dynamic data object within the database using a hierarchical structure, enhancing data manageability and accessibility. This structured approach significantly improves data integration and retrieval capabilities, enabling stakeholders to efficiently analyze trends and make data-driven decisions. The method/system's ability to generate exportable data objects tailored to specific audit procedures further enhances its adaptability, allowing it to meet the diverse requirements of various regulatory frameworks and facilitating smoother audits.

The methods and systems discussed herein drastically decrease the time resources required for managing, creating, and verifying carbon-related data, thereby accelerating workflow and enabling entities to swiftly adapt to market demands and regulatory changes. By centralizing carbon-related data and by storing the data in the specific hierarchical data structure, a database management solution can query the data faster and using fewer computing resources.

It is to be understood that both the foregoing general description and the following detailed description are exemplary and explanatory and are intended to provide further explanation of the disclosed embodiment and subject matter as claimed.

In some aspects, the techniques described herein relate to a method including: collecting, by one or more processors during a first electronic session, carbon-related data including attributes of one or more carbon-related protocols performed by an entity; generating, by the one or more processors, an immutable data object based on the collected data, the immutable data object including the attributes organized according to a hierarchical structure corresponding to a tree structure that defines a plurality of horizontal and vertical relationships between one or more devices associated with the one or more carbon-related protocols and one or more locations associated with the one or more carbon-related protocols; storing, by the one or more processors, the immutable data object as a data record in a dynamic field of a relational database, wherein when the immutable data object is queried, the attributes of one or more carbon-related protocols are provided in accordance with the hierarchical structure; receiving, by the one or more processors during a second electronic session, a request to generate carbon-related data associated with the entity; querying, by the one or more processors, the data record, wherein when the data record is queried, the one or more processors access the hierarchical structure of the immutable data object to access attributes of one or more carbon-related protocols; and generating, by the one or more processors, using the data retrieved from the hierarchical structure of the data object, one or more carbon credits based on the stored data object.

In some aspects, the techniques described herein relate to a method, wherein the immutable data object is a JavaScript object notation (JSON) file.

In some aspects, the techniques described herein relate to a method, wherein the tree structure further corresponds to one or more readings associated with one or more carbon-related protocols, one or more reporting periods, or any combination thereof.

In some aspects, the techniques described herein relate to a method, wherein the entity is associated with a plurality of reporting periods and generating the carbon-related data includes: calculating, for each reporting period of the plurality of reporting periods and by the one or more processors, an amount of carbon offset based on one or more rules associated with the carbon-related data protocol.

In some aspects, the techniques described herein relate to a method, further including: obtaining, by the one or more processors, second data corresponding to a project during a reporting period; and updating the immutable data object stored as the data record based on the second data.

In some aspects, the techniques described herein relate to a method, further including: comparing, by the one or more processors, the data corresponding to the entity with a plurality of data records of the relational database; determining, by the one or more processors, the data is duplicate data associated with a fraudulent act based on the comparing; and flagging, by the one or more processors, the duplicate data.

In some aspects, the techniques described herein relate to a method, wherein the relational database includes a history of one or more projects of the entity, the history including a plurality of data records, wherein each of the plurality of data records is associated with an identifier of a user and a time of creation.

In some aspects, the techniques described herein relate to a system, including: one or more processors coupled with memory and configured to: collect, during a first electronic session, carbon-related data including attributes of one or more carbon-related protocols performed by an entity; generate an immutable data object based on the collected data, the immutable data object including the attributes organized according to a hierarchical structure corresponding to a tree structure that defines a plurality of horizontal and vertical relationships between one or more devices associated with the one or more carbon-related protocols and one or more locations associated with the one or more carbon-related protocols; store the immutable data object as a data record in a dynamic field of a relational database, wherein when the immutable data object is queried, the attributes of one or more carbon-related protocols are provided in accordance with the hierarchical structure; receive, during a second electronic session, a request to generate carbon-related data associated with the entity; query the data record, wherein when the data record is queried, the one or more processors access the hierarchical structure of the immutable data object to access attributes of one or more carbon-related protocols; and generate using the data retrieved from the hierarchical structure of the data object, one or more carbon credits based on the stored data object.

In some aspects, the techniques described herein relate to a system, wherein the immutable data object is a JavaScript object notation (JSON) file.

In some aspects, the techniques described herein relate to a system, wherein the tree structure further corresponds to one or more readings associated with one or more carbon-related protocols, one or more reporting periods, or any combination thereof.

In some aspects, the techniques described herein relate to a system, wherein the entity is associated with a plurality of reporting periods and generating the carbon-related data includes: calculating, for each reporting period of the plurality of reporting periods an amount of carbon offset based on one or more rules associated with the carbon-related data protocol.

In some aspects, the techniques described herein relate to a system, wherein the one or more processors are further configured to: obtain second data corresponding to a project during a reporting period; and update the immutable data object stored as the data record based on the second data.

In some aspects, the techniques described herein relate to a system, wherein the one or more processors are further configured to: compare the data corresponding to the entity with a plurality of data records of the relational database; determine the data is duplicate data associated with a fraudulent act based on the comparing; and flag the duplicate data.

In some aspects, the techniques described herein relate to a system, wherein the relational database includes a history of one or more projects of the entity, the history including a plurality of data records, wherein each of the plurality of data records is associated with an identifier of a user and a time of creation.

In some aspects, the techniques described herein relate to a non-transitory computer readable storage medium including instructions stored thereon that, when executed by a processor, cause the processor to: collect, during a first electronic session, carbon-related data including attributes of one or more carbon-related protocols performed by an entity; generate an immutable data object based on the collected data, the immutable data object including the attributes organized according to a hierarchical structure corresponding to a tree structure that defines a plurality of horizontal and vertical relationships between one or more devices associated with the one or more carbon-related protocols and one or more locations associated with the one or more carbon-related protocols; store the immutable data object as a data record in a dynamic field of a relational database, wherein when the immutable data object is queried, the attributes of one or more carbon-related protocols are provided in accordance with the hierarchical structure; receive, during a second electronic session, a request to generate carbon-related data associated with the entity; query the data record, wherein when the data record is queried, the one or more processors access the hierarchical structure of the immutable data object to access attributes of one or more carbon-related protocols; and generate using the data retrieved from the hierarchical structure of the data object, one or more carbon credits based on the stored data object.

In some aspects, the techniques described herein relate to a non-transitory computer readable storage medium, wherein the immutable data object is a JavaScript object notation (JSON) file.

In some aspects, the techniques described herein relate to a non-transitory computer readable storage medium, wherein the tree structure further corresponds to one or more readings associated with one or more carbon-related protocols, one or more reporting periods, or any combination thereof.

In some aspects, the techniques described herein relate to a non-transitory computer readable storage medium, wherein the entity is associated with a plurality of reporting periods and generating the value includes: calculating, for each reporting period of the plurality of reporting periods an amount of carbon offset based on one or more rules associated with the carbon-related data protocol.

In some aspects, the techniques described herein relate to a non-transitory computer readable storage medium, wherein the instructions further cause the processors to: obtain second data corresponding to a project during a reporting period; and update the immutable data object stored as the data record based on the second data.

In some aspects, the techniques described herein relate to a non-transitory computer readable storage medium, wherein the instructions further cause the processors to: compare the data corresponding to the entity with a plurality of data records of the relational database; determine the data is duplicate data associated with a fraudulent act based on the comparing; and flag the duplicate data.

In some aspects, the techniques described herein relate to a method including: in response to receiving an audit request from an electronic device associated with a project, querying, by one or more processors, a set of data records using an attribute of the project, wherein at least one data record includes a data object for the project associated with carbon-related data protocol of a plurality of carbon-related protocols, the data object including data associated with the project organized according to a hierarchical structure; generating, by the one or more processors, a tree-structure corresponding to the set of data records including the data object having the hierarchical structure and data associated with at least one data record queried, the tree-structure having an organization corresponding to the project and further corresponding to a plurality of horizontal and vertical relationships between one or more devices associated with the one or more carbon-related protocols and one or more locations associated with the one or more carbon-related protocols; and exporting, by the one or more processors, the tree-structure to the electronic device, wherein the tree-structure is configured to provide access to the queried set of data records.

In some aspects, the techniques described herein relate to a method, further including: determining, by the one or more processors, a type of the audit request of a plurality of types of audit requests; modifying, by the one or more processors, one or more configurations associated with the hierarchical structure based on one or more preferences of the type of audit procedure; and generating, by the one or more processors, the data object including the data organized according to the modified hierarchical structure.

In some aspects, the techniques described herein relate to a method, further including: generating, by the one or more processors, carbon-related data based on the data queried.

In some aspects, the techniques described herein relate to a method, wherein exporting the tree-structure to the electronic device allows the audit request to verify the amount of carbon-related data generated.

In some aspects, the techniques described herein relate to a method, wherein the project is associated with a plurality of reporting periods and generating the carbon-related data includes: calculating, for each reporting period of the plurality of reporting periods and by the one or more processors, an amount of carbon offset based on one or more rules associated with the carbon credit protocol.

In some aspects, the techniques described herein relate to a method, wherein the data includes one or more locations, one or more assets, one or more reporting periods, one or more stakeholders, one or more readings, or any combination thereof, associated with the project.

In some aspects, the techniques described herein relate to a method, wherein the dynamic file is a JavaScript object notation (JSON) file.

In some aspects, the techniques described herein relate to a method, wherein the relational database includes a history of the project, the history including a plurality of data records, wherein each of the plurality of data records is associated with an identifier of a user and a time of creation.

In some aspects, the techniques described herein relate to a method, wherein the data includes the history of the project associated with an audit period of time.

In some aspects, the techniques described herein relate to a system, including: one or more processors coupled with memory and configured to: in response to receiving an audit request from an electronic device associated with a project, query a set of data records using an attribute of the project, wherein at least one data record includes a data object for the project associated with carbon-related data protocol of a plurality of carbon-related protocols, the data object including data associated with the project organized according to a hierarchical structure; generate a tree-structure corresponding to the set of data records including the data object having the hierarchical structure and data associated with at least one data record queried, the tree-structure having an organization corresponding to the project and further corresponding to a plurality of horizontal and vertical relationships between one or more devices associated with the one or more carbon-related protocols and one or more locations associated with the one or more carbon-related protocols; and export the tree-structure to the electronic device, wherein the tree-structure is configured to provide access to the queried set of data records.

In some aspects, the techniques described herein relate to a system, wherein the server is further configured to: determine a type of the audit request of a plurality of types of audit requests; modify one or more configurations associated with the hierarchical structure based on one or more preferences of the type of audit procedure; and generate the data object including the data organized according to the modified hierarchical structure.

In some aspects, the techniques described herein relate to a system, wherein the server is further configured to: generate carbon-related data based on the data queried.

In some aspects, the techniques described herein relate to a system, wherein exporting the tree-structure to the electronic device allows the audit request to verify the amount of carbon-related data generated.

In some aspects, the techniques described herein relate to a system, wherein the project is associated with a plurality of reporting periods and generating the carbon-related data includes: calculating, for each reporting period of the plurality of reporting periods and by the one or more processors, an amount of carbon offset based on one or more rules associated with the carbon credit protocol.

In some aspects, the techniques described herein relate to a system, wherein the data includes one or more locations, one or more assets, one or more reporting periods, one or more stakeholders, one or more readings, or any combination thereof, associated with the project.

In some aspects, the techniques described herein relate to a system, wherein the dynamic file is a JavaScript object notation (JSON) file.

In some aspects, the techniques described herein relate to a system, wherein the relational database includes a history of the project, the history including a plurality of data records, wherein each of the plurality of data records is associated with an identifier of a user and a time of creation.

In some aspects, the techniques described herein relate to a system, wherein the data includes the history of the project associated with an audit period of time.

In some aspects, the techniques described herein relate to a non-transitory computer readable storage medium including instructions stored thereon that, when executed by a processor, cause the processor to: in response to receiving an audit request from an electronic device associated with a project, query a set of data records using an attribute of the project, wherein at least one data record includes a data object for the project associated with carbon-related data protocol of a plurality of carbon-related protocols, the data object including data associated with the project organized according to a hierarchical structure; generate a tree-structure corresponding to the set of data records including the data object having the hierarchical structure and data associated with at least one data record queried, the tree-structure having an organization corresponding to the project and further corresponding to a plurality of horizontal and vertical relationships between one or more devices associated with the one or more carbon-related protocols and one or more locations associated with the one or more carbon-related protocols; and export the tree-structure to the electronic device, wherein the tree-structure is configured to provide access to the queried set of data records.

In some aspects, the techniques described herein relate to a non-transitory computer readable storage medium, wherein the instructions further cause the processor to: determine a type of the audit request of a plurality of types of audit requests; modify one or more configurations associated with the hierarchical structure based on one or more preferences of the type of audit procedure; and generate the data object including the data organized according to the modified hierarchical structure.

In some aspects, the techniques described herein relate to a non-transitory computer readable storage medium, wherein the instructions further cause the processor to generate carbon-related data based on the data queried.

In some aspects, the techniques described herein relate to a non-transitory computer readable storage medium, wherein exporting the tree-structure to the electronic device allows the audit request to verify the amount of carbon-related data generated.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a computer system for managing carbon-related data generation, according to an embodiment.

FIG. 2 illustrates a database for managing carbon-related data generation, according to an embodiment.

FIG. 3 illustrates a hierarchical structure, according to an embodiment.

FIG. 4 illustrates a flow chart for managing carbon-related data generation, according to an embodiment.

FIG. 5 illustrates a flow chart for exporting evidence for carbon-related data generation for an audit procedure, according to an embodiment.

FIG. 6 illustrates a graphical user interface for managing carbon-related data generation, according to an embodiment.

FIG. 7 illustrates a graphical user interface for managing carbon-related data generation, according to an embodiment.

FIG. 8 illustrates a graphical user interface for managing carbon-related data generation, according to an embodiment.

FIG. 9 illustrates a graphical user interface for managing carbon-related data generation, according to an embodiment.

FIG. 10 illustrates a graphical user interface for managing carbon-related data generation, according to an embodiment.

FIG. 11 illustrates a graphical user interface for managing carbon-related data generation, according to an embodiment.

FIG. 12 illustrates a graphical user interface for managing carbon-related data generation, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

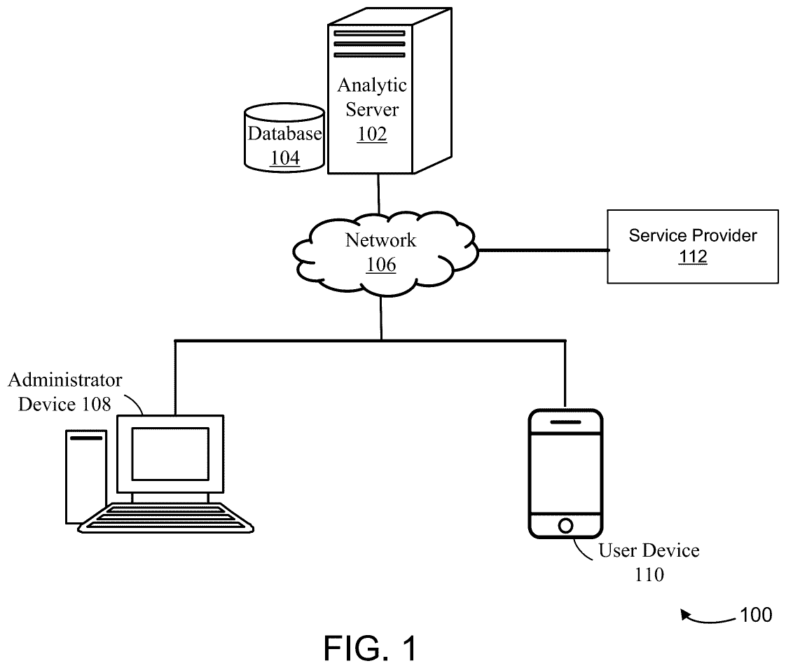

FIG. 1 illustrates components of a system 100 for managing carbon-related data generation, according to an embodiment. The system 100 may comprise an analytic server 102 with a database 104, an electronic administrator device 108, an electronic user device 110, and one or more service providers that are coupled with each other via hardware and software components of one or more networks 106. Examples of the networks 106 may include, but are not limited to, Local Area Network (“LAN”), Wireless Local Area Network (“WLAN”), Metropolitan Area Network (“MAN”), Wide Area Network (“WAN”), and the Internet. The communication over the network 106 may be performed in accordance with various communication protocols, such as Transmission Control Protocol and Internet Protocol (“TCP/IP”), User Datagram Protocol (“UDP”), and IEEE communication protocols.

The analytic server 102 may be any computing device comprising one or more processors and other computing hardware and software components. The analytic server 102 may be logically and physically organized within the same or different devices or structures and may be distributed across any number of physical structures and locations (e.g., cabinets, rooms, buildings, cities).

The analytic server 102 may be a computing device comprising a processing unit. The processing unit may include one or more processors with computer-readable medium, such as a random-access memory coupled to the processors. The analytic server 102 may be running algorithms or computer executable program instructions, which may be executed by a single processor or multiple processors in a distributed configuration. The analytic server 102 may be configured to interact with one or more software modules of a same or a different type operating within the system 100.

Non-limiting examples of the processor may include a microprocessor, an application specific integrated circuit, and a field programmable object array, among others. Non-limiting examples of the analytic server 102 may include a server computer, a workstation computer, a tablet device, and a mobile device (e.g., smartphone). Some embodiments may include multiple computing devices functioning as the analytic server 102. Some other embodiments may include a single computing device capable of performing the various tasks described herein.

The electronic administrator device 108 may be any computing device allowing an administrative user to interact with the analytic server 102. The electronic administrator device 108 may be any computing device comprising a processor and non-transitory machine-readable storage medium. The examples of the computing device may include, but are not limited to, a desktop computer, a laptop, a personal digital assistant (“PDA”), a smartphone, a tablet computer, and the like. The electronic administrator device 108 may comprise any number of input and output devices supporting various types of data, such as text, image, audio, video, and the like.

The database 104 may be any non-transitory machine-readable media configured to store data associated with carbon-related data generation. For instance, the database 104 may be a hybrid database that includes aspects of a relational database (e.g., an SQL database) and a non-relational database (e.g., a non-SQL database). The database 104 may include a relational database with dynamic fields, where a dynamic field can store a data object (e.g., file) as a data record. The data object can be a dynamic file (e.g., a JavaScript object notation (JSON) file) associated with a project of carbon-related data generation. The dynamic data object may be configured according to a hierarchical structure (e.g., a tree structure) with the capability of organizing and recording various relationships (e.g., horizontal relationships, vertical relationships) between attributes associated with the project. The dynamic data object may include locations, devices (sometimes referred to as assets), reporting periods, stakeholders, evidence, and amounts of carbon-related data, among other attributes associated with the projects. The dynamic data object may include recordings of when data was entered, from what user or device, and other identifying information to track data entry for later verification.

The database 104 may be part of the analytic server 102. The database 104 may be a separate component in communication with the analytic server 102. The database 104 may have a logical construct of data files, which may be stored in non-transitory machine-readable storage media, such as a hard disk or memory, controlled by software modules of a database program, and a database management system that executes the code modules (e.g., scripts) for various data queries and management functions. The database 104 may be a database that supports storing immutable data (e.g., to prove, during an audit procedure, that the data stored in the database 104 has not been altered).

The electronic user device 110 may be any computing device allowing a user to interact with the analytic server 102. The electronic user device 110 may be any computing device comprising a processor and non-transitory machine-readable storage medium. The examples of the computing device may include, but are not limited to, a PDA, a smartphone, a tablet computer, and the like. The electronic user device 110 may be a mobile device or handheld computer that provide a touchscreen interface with digital buttons and keyboard or physical buttons along with a physical keyboard. The electronic user device 110 may comprise integrated cameras, digital media players, and the global positional system (“GPS”) capabilities. The electronic user device 110 may comprise any number of input and output devices supporting various types of data, such as text, image, audio, video, and the like. The electronic user device 110 may capture evidence for one or more carbon-related data generation projects that allow verification of assertions associated with the projects. For example, the electronic user device 110 may take a picture or a recording of physical evidence and upload the picture or recording to the analytic server 102.

The service providers 112 may be or include servers or computers configured to transmit or provide services across the network 106. The service providers 112 may transmit or provide such services upon receiving requests for the services from any of the analytic server 102, the administrator device 108, or the user device 110. The term “service” as used herein includes the supplying or providing of information over a network and is also referred to as a communications network service. Examples of services include 5G broadband services, any voice, data, or video service provided over a network, smart-grid network, digital telephone service, cellular service, Internet protocol television (IPTV), etc.

Carbon-related data generation can take various forms, including renewable energy projects, afforestation and reforestation initiatives, energy efficiency measures, and the adoption of cleaner technologies, among other examples. Each of the forms relate to a type of protocol, where a protocol is a mechanism created by a governing agency or registry that includes rules and regulations for the creation of a carbon-related data. The protocol may define what activities, data, information, and supportive evidence is required for carbon-related data generation, and may define what calculations are used to produce a carbon-related data. Some types of protocols may include various types of methane abatement projects (e.g., converting high emission devices to low emission devices, converting methane driven pumps to electric driven pumps), distributed renewables (e.g., solar generation, solar microgeneration in private residencies), low carbon fuel standards (e.g., standards specific to a country, state, province, or other entity), among other types of protocols that can change any day (e.g., additional types created). As the devices, jurisdictions, and carbon-related data generation processes for each type of protocol varies, so to does the system for collecting data, verifying data, and the requirements (e.g., regulations) for generating (e.g., calculating) carbon-related data vary. However, having multiple systems (e.g., database, process, structure) for each type of protocol is difficult to manage and inefficient as new protocols are consistently being created. The techniques as described herein support a protocol agnostic managing system for carbon-related data generation.

Therefore, in some embodiments, carbon-related data may refer to a value or credit associated with a carbon-related project.

Each type of protocol may be deconstructed into attributes. For example, a protocol may include multiple projects, locations (e.g., a physical location), devices (e.g., physical items that exist at the locations), reporting periods (e.g., a defined start and end date aligned to a time period in which verification or the creation of carbon-related data takes place), readings (e.g., information or data backed by evidence that change over time), and carbon-related data.

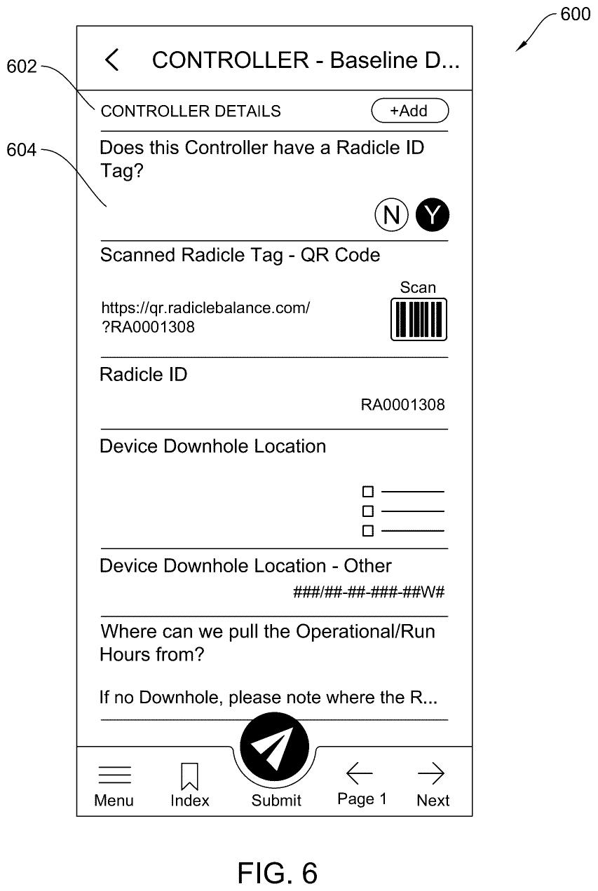

The analytic server 102 may provide a mobile application for a user to perform various operations related to managing carbon-related data generation by logging into the user's account via the mobile application on the electronic user device 110. For example, the analytic server 102 may display one or more interactive elements on the user device 110 that allow the user to fill out a form associated with a carbon-related data generation project. The user may collect various forms of evidence to support assertions (e.g., one or more devices is at a physical location and is owned by a stakeholder of the project, evidence for an assertion of carbon reduction, evidence for values used in calculating carbon-related data). For example, the user may collect readings (e.g., field data) associated with a device at a physical location by taking a picture of the device. The user may input the evidence, field data (e.g., a picture of a meter indicating a supply pressure), assertions, and other data associated with the project to the analytic server 102 via the user device 110. For example, the analytic server 102 may display on the user device 110 one or more interactive fields for the user to fill out based on information associated with the project, as described in relation to FIG. 6. In some cases, the analytic server 102 may collect evidence for the project from the service providers 112 (e.g., calling APIs of the service providers 112, using automated scraping engines).

Upon the user completing and submitting the form, the analytic server 102 may receive the form. For example, the analytic server 102 may receive photo or video data of the evidence or a JSON payload of the form from the user device 110. For example, the form may be configured with various rules to define types of data inputted into each field of the form. The form may be different for each type of protocol such that the fields of the form may change based on the type of protocol associated with the form and the responses (e.g., input) of the user. The form may automatically classify (based on the rules) the inputs of the various fields to one of multiple attributes corresponding to the associated protocol. Based on the classification, the user device 110 may send the JSON payload to the analytic server 102, where the JSON payload includes the classified data.

Upon reception, the analytic server 102 may process the JSON payload and/or the photo or video data. To do so, the analytic server 102 may compare the classified data with a hierarchical structure, where the hierarchical structure (e.g., a tree structure) defines relationships between attributes. For example, the analytic server 102 may determine a device type associated with the payload. If the device type does not exist within the hierarchical structure, the analytic server 102 may update a hierarchical structure by placing the new device type in the hierarchical structure and creating relationships between the new device type and other attributes within the hierarchical structure. For example, the device type may be a downhole (e.g., for extracting oil). The downhole location may have a parent-child relationship with a pneumatic pump located at a surface location as the downhole location may be the same as the surface location. The downhole location may have a horizontal relationship with the pneumatic pump at the surface location as the downhole location may be different from the surface location of the pneumatic pump (e.g., adjacent to). In some cases, the analytic server 102 may call one or more APIs of the service providers 112 to utilize character recognition technologies (e.g., optical character recognition (OCR)) to generate computer readable text from the photo or video data.

The analytic server 102 may ingress the JSON payload and/or the photo or video data into the database 104. To do so, the analytic server 102 may hash the data using (e.g., check the data against) one or more hashing algorithms (e.g., cyclic redundancy check (CRC), message digest algorithm (MD5), secure hash algorithm (SHA)), check for duplicates, and classify the data based on the hierarchical structure. For example, to check for duplicates, the analytic server 102 may compare the data against other data stored in the database 104. By doing so, the analytic server 102 may determine whether the data is duplicate data (e.g., data already stored in the database 104 or similar to data stored in the database 104) and can flag potentially fraudulent activity. For example, a user may attempt to create multiple sets of carbon-related data using same or similar data by creating fictitious projects. For example, the user may have multiple home addresses or share land or other devices with other users (e.g., stakeholders), among other examples, and may attempt to “double dip” by using a second home address but a same device, or multiple users using the same device to generate different carbon-related data. In some embodiments, the analytic server 102 may generate a data objects, such as file (e.g., a JSON file, a dynamic file) to ingress into the database 104 as a single data record.

The analytic server 102 may generate one or more carbon-related data based on data stored in the database 104. For example, the database 104 may include various data records, each associated with one or more reporting periods. For each reporting period, the analytic server 102 may calculate a number of carbon-related data generated by devices included in the data records. For instance, each protocol may include rules that define how to calculate a carbon-related data. The analytic server 102 may determine a device of a data record obtained from the database 104. The analytic server 102 may determine a type of protocol associated with the device and a set of rules associated with the type of protocol. Based on the set of rules and values included in the data records, the analytic server 102 may calculate the number of carbon-related data. In some cases, the analytic server 102 may only utilize values that are supported by evidence (e.g., a photo of the value on a meter). The analytic server 102 may store, in the database 104, a snapshot (e.g., a representation of, a record) of the calculation (including the values used, the time of the calculation, the equation used, etc.) to support an audit procedure.

As used herein, a data object may refer to a collection of data organized in a specific structure, often used within the context of programming and data management. It generally represents a model or structure of real-world entities using properties and behaviors encapsulated within a defined class or type. Data objects can be simple, holding basic data like numbers and strings, or more complex, containing multiple types of information and methods for processing that data. Data objects are sometimes referred to herein as files. However, it is expressly understood that data objects are not limited to files.

The electronic administrator device 108 may be operated by an employee/administrator in carbon-related data generation. The administrator may interface with the administrator device 108 via a graphical user interface (GUI) of the administrator device 108. The administrator may view data associated with a project via the GUI. For example, the analytic server 102 may query the database 104 for data records stored in the database 104 to provide access to the hierarchical structure including the data associated with the project. In some embodiments, the administrator may verify the data is correct via the GUI. If the data is not correct, the administrator device 108 may flag the data and send a notification to the user to collect additional data.

The administrator device 108 may be operated to provide an exportable file and/or a visual display on the GUI of the administrator device 108 for an audit procedure. For example, different protocols may have respective audit procedures that are used to verify whether created carbo-related data where legitimately calculated with evidence supported data. Additionally, each audit procedure may be performed by various entities, each with respective personal preferences. Complying with the various procedures and preferences can be highly resource and time consumptive, making audits difficult to pass. Using the techniques as described herein, systems can successfully comply with the various procedures and preferences in a highly reduced amount of time and with reduces amounts of resources.

In some cases, the administrator device 108 may be configured to collect data from the database 104. For example, the administrator device 108 may determine a first type of audit procedure associated with a first type of protocol. The administrator device 108 may query the database 104 for data corresponding to one or more projects associated with the protocol. The administrator device 108 may obtain one or more dynamic files and/or evidence (e.g., photos, videos, etc.) associated with the projects. The administrator device 108 may generate a package (e.g., an export package) based on a framework. The framework can take in as input the dynamic files and evidence and organize the files and evidence according to a hierarchical structure. In some embodiments, the hierarchical structure may be configurable based on the type of protocol, the type of audit procedure, and the preferences.

In some embodiments, the package may include a file system. For example, the file system may include various folders including evidence to support assertions made for generating carbon-related data. For instance, a folder may be associated with an operator. Within the operator folder may be a surface location folder including various device type folders (e.g., a downhole folder). In some cases, the package may be configured to comply with data ingress preferences. In some examples, the package may include demonstrations (e.g., snapshots) of the calculations made to generate the carbon-related data.

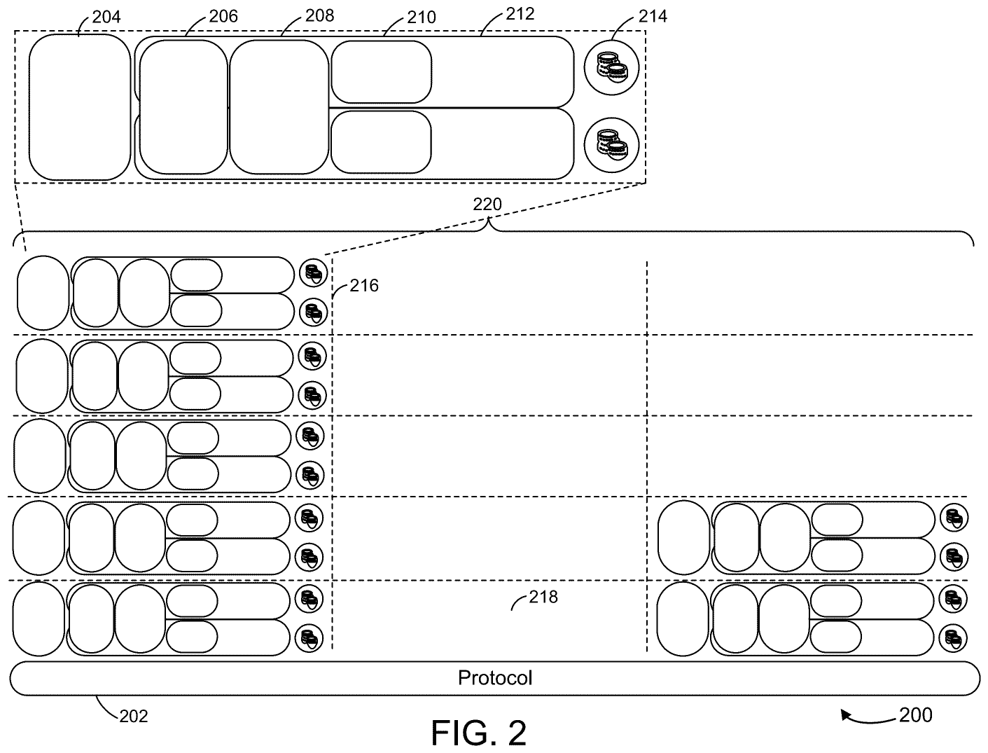

FIG. 2 illustrates a database 200 for managing carbon-related data generation, according to an embodiment. The database 200 may be similar to or the same as the database 104 described herein with reference to FIG. 1. The database 200 may be a hybrid database that includes aspects of a relational database and a non-relational database. The database 200 may allow for storage of data in a manner that allows for faster storage and retrieval of data. For instance, when the data is stored within the database 200 using methods and systems discussed herein, the data can be queried faster than when the data is stored and/or managed using conventional methods. Therefore, technical improvements are achieved via storing the data using the methods and systems discussed herein.

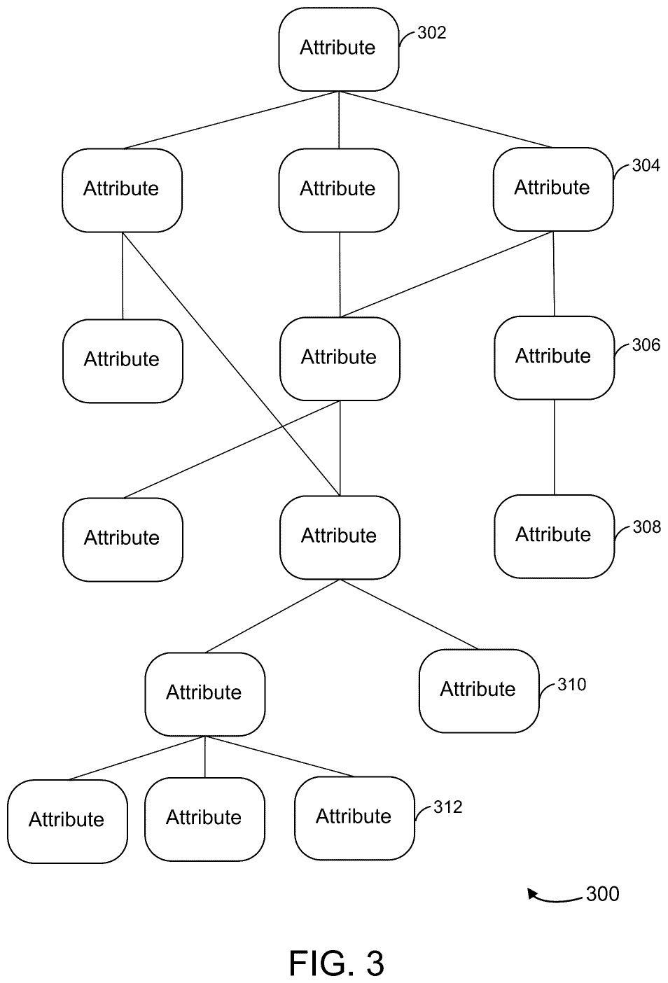

The database 200 may include a protocol 202 (e.g., a table) including various fields 220 including various data records. The database 200 may store dynamic files or other types of data as data records in the various fields 220. For example, the database 200 may store a dynamic file as a data record 216 and another type of data (e.g., a data point, binary, varbinary, and/or image data) as a data record 218. The data record 216 may include various attributes structured according to a hierarchical structure, as described herein with relation to FIG. 3. The attributes may include, but are not limited to, a project 204, a location 206, a device 208, a reading 210, a reporting period 212, and an amount of carbon-related data 214.

The protocol 202 may be associated with one type of protocol of multiple types of protocols. Each type of protocol may be deconstructed into core components (e.g., attributes). For example, the protocol 202 may include multiple projects 204, where a project is a grouping of one or more subprojects that take place at a location. Each project 204 may be associated with one or more locations 206 (e.g., farm, oil well, wind farm, etc.), one or more devices 208 (e.g., a field, a solar-powered pump, a parcel of land, etc.), a reporting period 212 (e.g., a defined start and end date aligned to a time period in which verification or the creation of a carbon-related data takes place), readings 210 (e.g., soil samples, volumes, ownership information, readings from farm equipment, etc.), and carbon-related data 214 (e.g., carbon-related data generated for the reporting period 212 based on the readings 210). Each device 208 may include multiple reporting periods 212, where each reporting period 212 may be associated with respective readings 210 and carbon-related data 214.

In a non-limiting example, the protocol 202 may be associated with greenhouse gas (GHG) emission reduction from Alberta emission offset system projects. A project 204 associated with the GHG emission reduction protocol 202 may be defined as pool H including a grouping of hundreds of individual well sites. A first location 206 may be associated with a well site operated by a company. The data associated with the first location 206, stored in the database 200, may include evidence of ownership of the location by the company (e.g., a lease sign photo, data from a government database verifying ownership, etc.). A first device 208 at the first location 206 may be associated with a device abating methane. The data associated with the first device 208 may include evidence of the device being installed or present at the location 206 (e.g., a photo of the device, coordinates of the device, ownership records of the device). A reporting period 210 may cover the year 2022. Readings 210 associated with the first device 208 may include gas analysis data (e.g., composition of gas being prevented from being released into the atmosphere), operating hours, stroke counts, and signed documents. In some cases, the readings 210 may be collected from third-party service providers via respective API calls or automated scraping engines (e.g., collecting operating hours from a government cloud service, stroke counts from a database or a control system, and signed documents from users outside of the system).

FIG. 3 illustrates a hierarchical structure 300 for managing carbon-related data generation, according to an embodiment. The hierarchical structure 300 may be a tree structure that defines relationships between various attributes. In a non-limiting example, the structure 300 may include a protocol 302. The protocol 302 may be in a parent-child relationship with various projects 304. Each project 304 may have relationships with one or more locations 306 and/or one or more devices 308. Each location 306 may have relationships with one or more devices 308. Each device 308 may have relationships with one or more reporting periods 310. Each reporting period 310 may have relationships with one or more readings 312. While the hierarchical structure 300 illustrated in FIG. 3 depicts one example, multiple configurations of attributes and relationships thereof are possible. Each attribute may have a relationship with any other attribute to create various pairings of vertical and horizontal relationships.

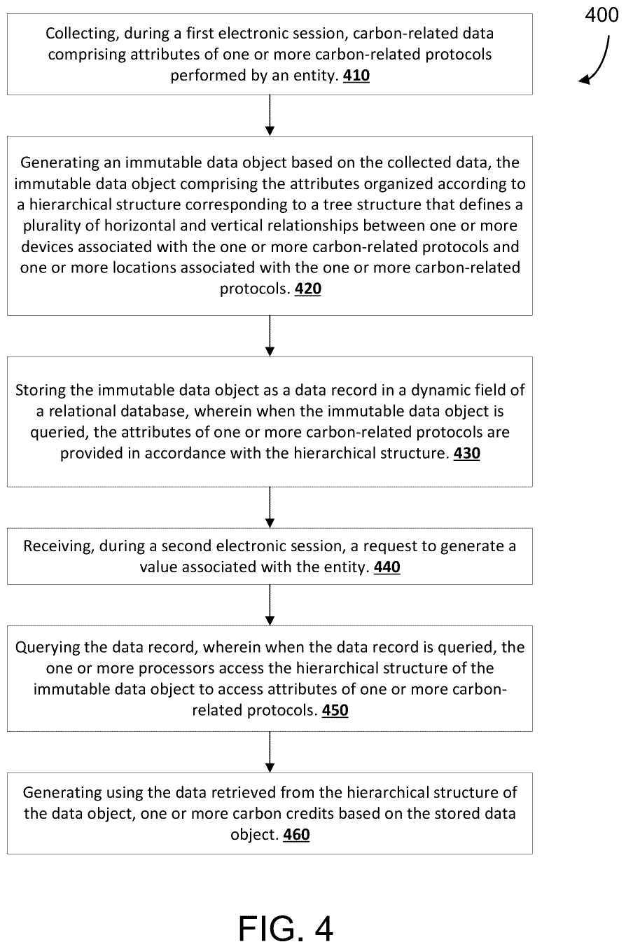

FIG. 4 illustrates execution of a method 400 for managing carbon-related data generation, according to an embodiment. Other embodiments may comprise additional or alternative steps or may omit some steps altogether. Even though certain aspects of the embodiments disclosed herein are described as managing carbon-related data, the functionalities described herein may be applicable to management of any other applications.

At step 410, the analytics server may collect, during a first electronic session, carbon-related data comprising attributes of one or more carbon-related protocols performed by an entity. The analytic server may collect data corresponding to a project associated with a carbon-related data protocol of a plurality of carbon-related data protocols. In some examples, the collected data includes one or more locations, one or more devices, one or more reporting periods, one or more readings, an amount of carbon-related data, or any combination thereof, associated with the project. The data may be collected during an electronic session where a user accesses various graphical user interfaces (e.g., depicted in FIGS. 6-12) to input carbon-related data associated with a project and/or an entity.

At step 420, the analytics server may generate an immutable data object based on the collected data, the immutable data object comprising the attributes organized according to a hierarchical structure corresponding to a tree structure that defines a plurality of horizontal and vertical relationships between one or more devices associated with the one or more carbon-related protocols and one or more locations associated with the one or more carbon-related protocols.

The analytic server may generate a data object (e.g., file) for the project based on the collected data, the file comprising the data organized according to a hierarchical structure. In some cases, the file is a JSON file, where attributes of the JSON file are organized according to the hierarchical structure. In some cases, the hierarchical structure is a tree structure that defines a plurality of horizontal and vertical relationships between each of the one or more devices, each of the one or more locations, each of the one or more readings, each of the one or more reporting periods, or any combination thereof. The data object may include a hierarchy as depicted and described in FIG. 3. As described herein, the data object may be immutable. For instance, the data object and its hierarchy may be protected by the analytics server, such that other actors cannot change its content.

At step 430, the analytics server may store the immutable data object as a data record in a dynamic field of a relational database, wherein when the immutable data object is queried, the attributes of one or more carbon-related protocols are provided in accordance with the hierarchical structure.

The analytic server may store the file as a data record in a dynamic field of a relational database. In some cases, the analytic server may compare, prior to storing the file in the relational database, the data corresponding to the project with a plurality of data records of the relational database. The analytic server may determine the data is duplicate data associated with a fraudulent act based on the comparing. The analytic server may flag the duplicate data. In some cases, the analytic server may obtain second data corresponding to the project during a reporting period and update the file stored as the data record based on the second data. In some cases, the relational database comprises a history of the project, the history comprising a plurality of data records, wherein each of the plurality of data records is associated with an identifier of a user and a time of creation. In some cases, the data stored in the relational database is immutable. As depicted in FIG. 2-3, the analytics server may store the data object in a hybrid data repository.

At step 440, the analytics server may receive, during a second electronic session, a request to generate a value associated with the entity. The analytics server may receive a request for generating a value associated with the entity/project.

At step 450, the analytics server may query the data record, wherein when the data record is queried, the one or more processors access the hierarchical structure of the immutable data object to access attributes of one or more carbon-related protocols. At step 460, the analytics server may generate using the data retrieved from the hierarchical structure of the data object, one or more carbon credits based on the stored data object. The analytic server may query the data record using an attribute of a project, wherein when the data record is queried, the one or more processors access the hierarchical structure of the file to access data corresponding to the project. The analytic server may generate, using the data retrieved from the hierarchical structure of the file, one or more carbon-related data based on the stored file. In some cases, to generate the carbon-related data (e.g., value), the analytic server may calculate, for each reporting period of the plurality of reporting periods, an amount of carbon offset based on one or more rules associated with the carbon-related data protocol.

As used herein, the carbon-related data may refer to a value or carbon credit associated with the project and/or an entity. Therefore, in some embodiments, the analytic server may use various rules to generate a value associated with the project/entity using the data stored using the methods and systems discussed herein.

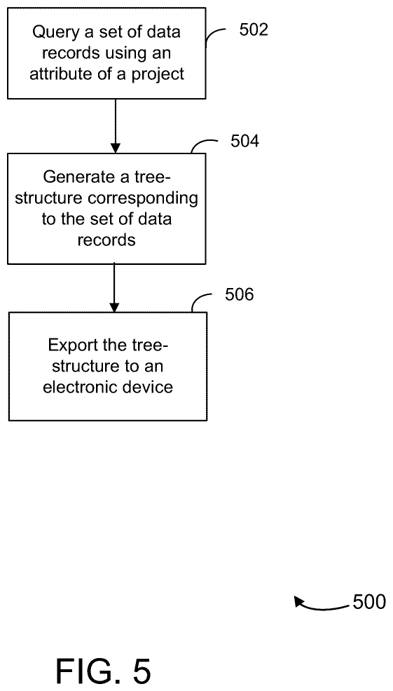

FIG. 5 illustrates execution of a method 500 for managing carbon-related data generation, according to an embodiment. Other embodiments may comprise additional or alternative steps or may omit some steps altogether. Even though certain aspects of the embodiments disclosed herein are described as managing carbon-related data, the functionalities described herein may be applicable to management of any other applications.

At step 502, in response to receiving an audit request from an electronic device, an analytic server may query a set of data records using an attribute of a project, wherein at least one data record stores a file for the project associated with a carbon-related data protocol of a plurality of carbon-related data protocols, the file comprising data associated with the project organized according to a hierarchical structure. In some cases, the dynamic file is a JSON file. In some cases, the relational database comprises a history of the project, the history comprising a plurality of data records, wherein each of the plurality of data records is associated with an identifier of a user and a time of creation. In some cases, the data comprises the history of the project associated with an audit period of time. In some cases, the data stored in the database is immutable.

At step 504, the analytic server may generate a tree-structure corresponding to the set of data records comprising the file having the hierarchical structure and data associated with at least one data record queried, the tree-structure having an organization corresponding to the carbon-related data project. In some cases, the analytic server may generate an amount of carbon-related data based on the data. In some cases, the project is associated with a plurality of reporting periods. To generate the amount of carbon-related data, the analytic server may calculate, for each reporting period of the plurality of reporting periods, an amount of carbon offset based on one or more rules associated with the carbon-related data protocol.

At step 506, the analytic server may export the tree-structure to the electronic device, wherein the tree-structure is configured to provide access to the queried set of data records. In some cases, the data comprises one or more locations, one or more devices, one or more reporting periods, one or more stakeholders, one or more readings, an amount of carbon-related data, or any combination thereof, associated with the project. In some cases, the hierarchical structure defines a plurality of horizontal and vertical relationships between each of the one or more devices, each of the one or more locations, each of the one or more stakeholders, each of the one or more readings, and each of the one or more reporting periods. In some cases, the analytic server may determine a type of the audit request of a plurality of types of audit requests. The analytic server may modify one or more configurations associated with the hierarchical structure based on one or more preferences of the type of audit request. The analytic server may generate the tree-structure comprising the data organized according to the modified hierarchical structure. In some cases, exporting the tree-structure to the electronic device allows the audit request to verify the amount of carbon-related data generated.

FIG. 6 illustrates a GUI 600 for managing carbon-related data generation, according to an embodiment. The GUI 600 may illustrate an example form 602 including various fields 604. The form 602 may be a form configured to support a first type of protocol of multiple types of protocols. For example, the form 602 may include the fields 604 that are associated with the first type of protocol. Each field 604 may correspond to an attribute, where a data processing system can generate a JSON payload that includes data from each field, where the JSON payload is organized according to a hierarchical structure.

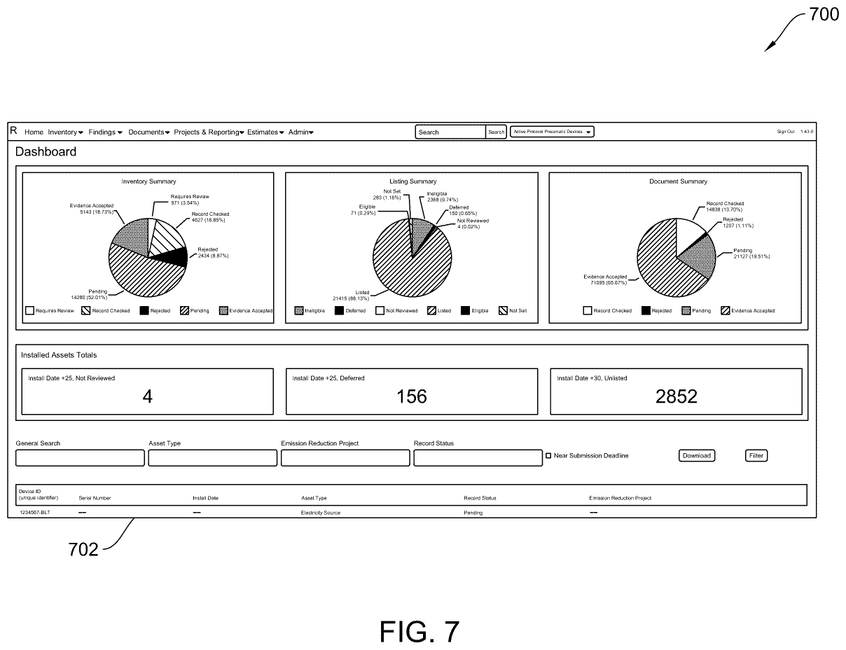

FIG. 7 illustrates a GUI 700 for managing carbon-related data generation, according to an embodiment. The GUI 700 may illustrate an example dashboard 702. The dashboard 702 may display a summary of different status, inventories, listings, and documents associated with one or more protocols, projects, devices, or other attributes.

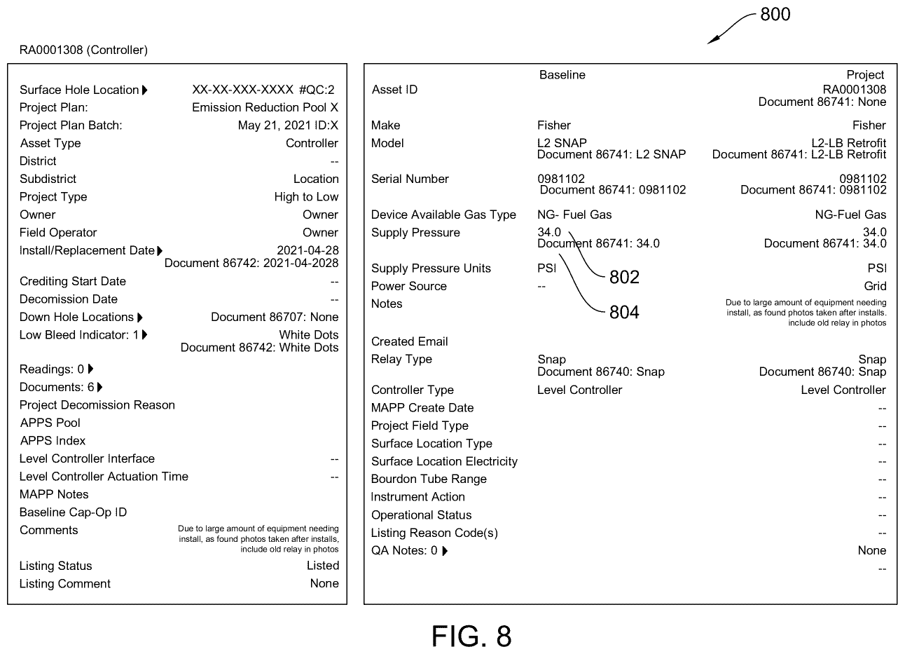

FIG. 8 illustrates a GUI 800 for managing carbon-related data generation, according to an embodiment. The GUI 800 may illustrate data associated with an example device (e.g., RA0001308) stored in a database associated with an analytic server. The GUI 800 can illustrate various assertions associated with the device, indications of whether evidence supports the assertions, and the evidence (e.g., documents, images) if available. For example, the GUI 800 may depict an assertion 802 that the supply pressure of the device is 34 psi. The assertion is supported by evidence 804 (e.g., document 86740).

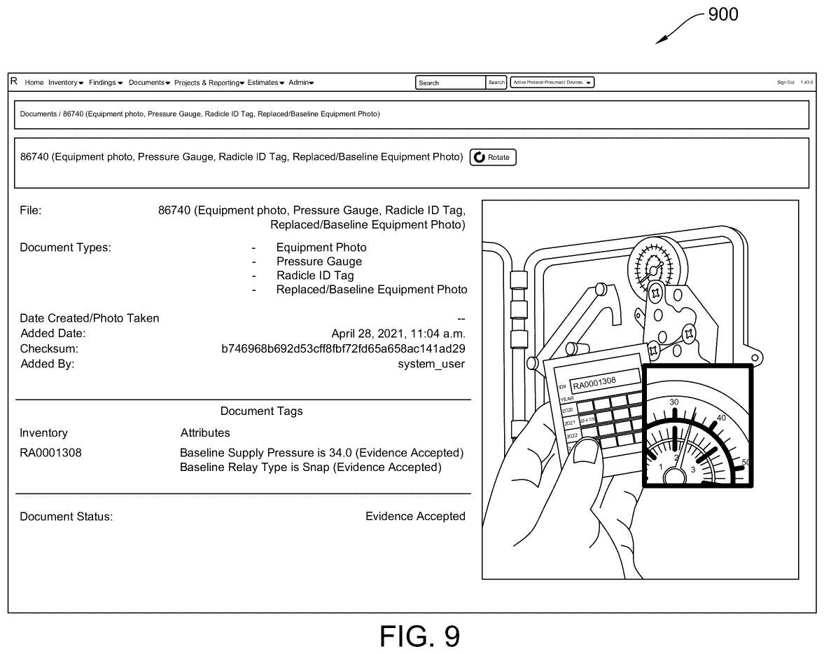

FIG. 9 illustrates a GUI 900 for managing carbon-related data generation, according to an embodiment. The GUI 900 may illustrate a document providing evidence of an assertion. For example, the document may be document 86740 depicting photographic evidence of a pressure gauge of the device at a period of time. The GUI 900 may illustrate a status of the document (e.g., accepted, pending, rejected, etc.).

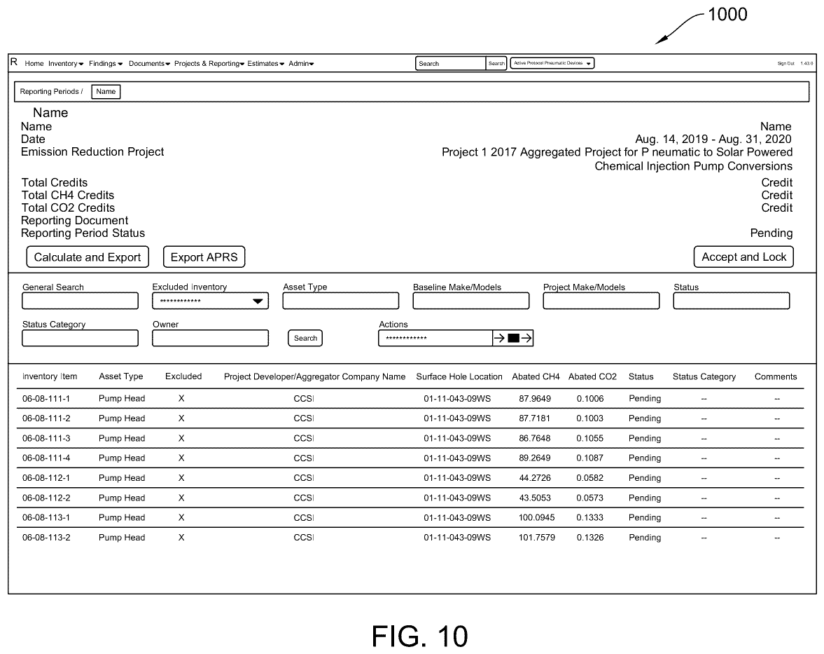

FIG. 10 illustrates a GUI 1000 for managing carbon-related data generation, according to an embodiment. The GUI 1000 may illustrate data associated with a reporting period. The GUI 1000 may illustrate multiple (e.g., hundreds) of devices (e.g., assets) across multiple locations. During the reporting period, the GUI 1000 may illustrate an amount of GHG abated for each device (e.g., one or more assertions) as well as an indication of a status of the assertion.

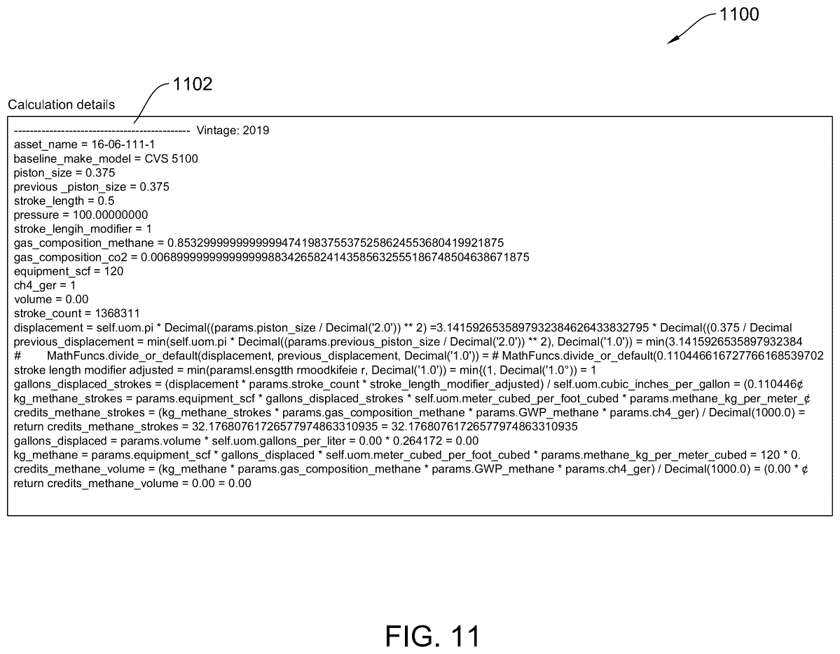

FIG. 11 illustrates a GUI 1100 for managing carbon-related data generation, according to an embodiment. The GUI 1100 may illustrate a snapshot 1102 of a calculation for generating carbon-related data associated with a type of protocol during a reporting period. The snapshot 1102 is associated with a device and multiple readings. The snapshot 1102 may include values used in the calculation, as well as equations used to calculate the amount of carbon-related data.

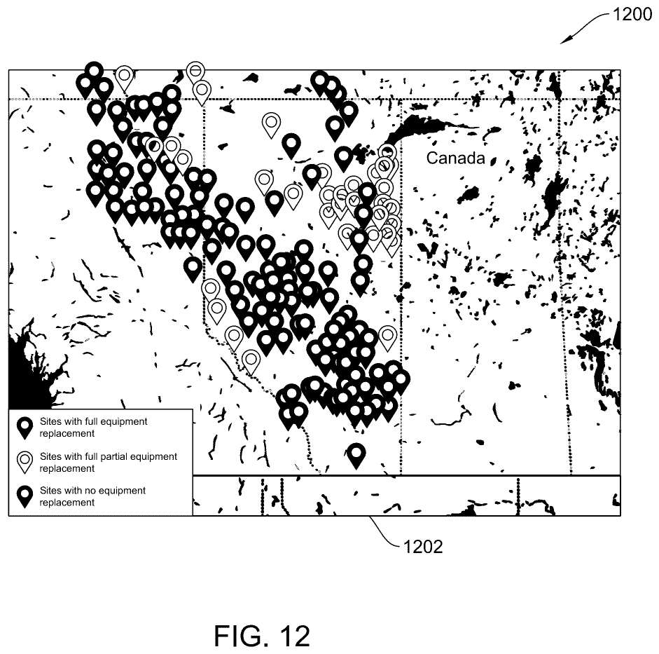

FIG. 12 illustrates a GUI 1200 for managing carbon-related data generation, according to an embodiment. The GUI 1200 may illustrate a map 1202. The map 1202 may indicate one or more locations associated with one or more devices and a status of the equipment (e.g., assets) at the site. For example, the map 1202 may illustrate a section of Alberta, Canada. The map 1202 may indicate multiple locations via a map marker. Each map marker may be a different color to indicate the status of the equipment at the location (e.g., site). The status may include whether all of the equipment at the site have been replaced, some of the equipment have been replaced, or no equipment have been replaced. In some embodiments, other types of indications may be used (e.g., dots, size, shapes, etc.).

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (“CD”), laser disc, optical disc, digital versatile disc (“DVD”), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method comprising:
collecting, by one or more processors during a first electronic session, carbon-related data comprising attributes of one or more carbon-related protocols performed by an entity;
generating, by the one or more processors, an immutable data object based on the collected data, the immutable data object comprising the attributes organized according to a hierarchical structure corresponding to a tree structure that defines a plurality of horizontal and vertical relationships between one or more devices associated with the one or more carbon-related protocols and one or more locations associated with the one or more carbon-related protocols;
storing, by the one or more processors, the immutable data object as a data record in a dynamic field of a relational database, wherein when the immutable data object is queried, the attributes of one or more carbon-related protocols are provided in accordance with the hierarchical structure;
receiving, by the one or more processors during a second electronic session, a request to generate a value associated with the entity;
querying, by the one or more processors, the data record, wherein when the data record is queried, the one or more processors access the hierarchical structure of the immutable data object to access attributes of one or more carbon-related protocols; and
generating, by the one or more processors, using the data retrieved from the hierarchical structure of the data object, one or more carbon credits based on the stored data object.

2. The method of claim 1, wherein the immutable data object is a JavaScript object notation (JSON) file.

3. The method of claim 1, wherein the tree structure further corresponds to one or more readings associated with one or more carbon-related protocols, one or more reporting periods, or any combination thereof.

4. The method of claim 1, wherein the entity is associated with a plurality of reporting periods and generating the value comprises:
calculating, for each reporting period of the plurality of reporting periods and by the one or more processors, an amount of carbon offset based on one or more rules associated with the carbon-related data protocol.

5. The method of claim 1, further comprising:
obtaining, by the one or more processors, second data corresponding to a project during a reporting period; and
updating the immutable data object stored as the data record based on the second data.

6. The method of claim 1, further comprising:
comparing, by the one or more processors, the data corresponding to the entity with a plurality of data records of the relational database;
determining, by the one or more processors, the data is duplicate data associated with a fraudulent act based on the comparing; and
flagging, by the one or more processors, the duplicate data.

7. The method of claim 1, wherein the relational database comprises a history of one or more projects of the entity, the history comprising a plurality of data records, wherein each of the plurality of data records is associated with an identifier of a user and a time of creation.

8. A system, comprising:
one or more processors coupled with memory and configured to:
collect, during a first electronic session, carbon-related data comprising attributes of one or more carbon-related protocols performed by an entity;
generate an immutable data object based on the collected data, the immutable data object comprising the attributes organized according to a hierarchical structure corresponding to a tree structure that defines a plurality of horizontal and vertical relationships between one or more devices associated with the one or more carbon-related protocols and one or more locations associated with the one or more carbon-related protocols;
store the immutable data object as a data record in a dynamic field of a relational database, wherein when the immutable data object is queried, the attributes of one or more carbon-related protocols are provided in accordance with the hierarchical structure;
receive, during a second electronic session, a request to generate a value associated with the entity;
query the data record, wherein when the data record is queried, the one or more processors access the hierarchical structure of the immutable data object to access attributes of one or more carbon-related protocols; and
generate using the data retrieved from the hierarchical structure of the data object, one or more carbon credits based on the stored data object.

9. The system of claim 8, wherein the immutable data object is a JavaScript object notation (JSON) file.

10. The system of claim 8, wherein the tree structure further corresponds to one or more readings associated with one or more carbon-related protocols, one or more reporting periods, or any combination thereof.

11. The system of claim 8, wherein the entity is associated with a plurality of reporting periods and generating the value comprises:
calculating, for each reporting period of the plurality of reporting periods an amount of carbon offset based on one or more rules associated with the carbon-related data protocol.

12. The system of claim 8, wherein the one or more processors are further configured to:
obtain second data corresponding to a project during a reporting period; and
update the immutable data object stored as the data record based on the second data.

13. The system of claim 8, wherein the one or more processors are further configured to:
compare the data corresponding to the entity with a plurality of data records of the relational database;
determine the data is duplicate data associated with a fraudulent act based on the comparing; and
flag the duplicate data.

14. The system of claim 8, wherein the relational database comprises a history of one or more projects of the entity, the history comprising a plurality of data records, wherein each of the plurality of data records is associated with an identifier of a user and a time of creation.

15. A non-transitory computer readable storage medium comprising instructions stored thereon that, when executed by a processor, cause the processor to:
collect, during a first electronic session, carbon-related data comprising attributes of one or more carbon-related protocols performed by an entity;
generate an immutable data object based on the collected data, the immutable data object comprising the attributes organized according to a hierarchical structure corresponding to a tree structure that defines a plurality of horizontal and vertical relationships between one or more devices associated with the one or more carbon-related protocols and one or more locations associated with the one or more carbon-related protocols;
store the immutable data object as a data record in a dynamic field of a relational database, wherein when the immutable data object is queried, the attributes of one or more carbon-related protocols are provided in accordance with the hierarchical structure;
receive, during a second electronic session, a request to generate carbon-related data associated with the entity;
query the data record, wherein when the data record is queried, the one or more processors access the hierarchical structure of the immutable data object to access attributes of one or more carbon-related protocols; and
generate using the data retrieved from the hierarchical structure of the data object, one or more carbon credits based on the stored data object.

16. The non-transitory computer readable storage medium of claim 15, wherein the immutable data object is a JavaScript object notation (JSON) file.

17. The non-transitory computer readable storage medium of claim 15, wherein the tree structure further corresponds to one or more readings associated with one or more carbon-related protocols, one or more reporting periods, or any combination thereof.

18. The non-transitory computer readable storage medium of claim 15, wherein the entity is associated with a plurality of reporting periods and generating the carbon-related data comprises:
calculating, for each reporting period of the plurality of reporting periods an amount of carbon offset based on one or more rules associated with the carbon-related data protocol.

19. The non-transitory computer readable storage medium of claim 15, wherein the instructions further cause the processors to:
obtain second data corresponding to a project during a reporting period; and
update the immutable data object stored as the data record based on the second data.

20. The non-transitory computer readable storage medium of claim 15, wherein the instructions further cause the processors to:
compare the data corresponding to the entity with a plurality of data records of the relational database;
determine the data is duplicate data associated with a fraudulent act based on the comparing; and
flag the duplicate data.
